(19) United States
(12) Patent Application Publication
(10) Pub. No.: US 2023/0406973 A1
(43) Pub. Date: Dec. 21, 2023

(54) HIGH DENSITY POLYETHYLENE COMPOSITIONS WITH LONG-CHAIN BRANCHING

(71) Applicant: Exxonmobil Chemical Patents Inc., Baytown, TX (US)

(72) Inventors: Nino RUOCCO, Houston, TX (US); Nilesh SAVARGAONKAR, Manvel, TX (US); Timothy M. BOLLER, Houston, TX (US); Etienne R.H. LERNOUX, Longueville (BE); Robert M. CANRIGHT, Huffman, TX (US)

(21) Appl. No.: 18/250,309

(22) PCT Filed: Dec. 1, 2021
(86) PCT No.: PCT/US2021/072674

§ 371 Date: Apr. 24, 2023

Related U.S. Application Data
(60) Provisional application No. 63/199,128, filed on Dec. 8, 2020.

(51) Int. Cl. C08F 210/16

(52) U.S. Cl. CPC C08F 210/16

(57) ABSTRACT

Provided herein are polyethylene compositions having a combination of properties including: density from about 0.930 to 0.975 g/cm³; broad molecular weight distributions (Mw/Mn≥10 and/or Mz/Mn≥80) and a highly branched architecture (e.g., g′_{LCB} less than or equal to 0.85, preferably less than or equal to 0.75). The polyethylene compositions may further have a low molecular weight fraction (LMWF) and a high molecular weight fraction (HMWF), such that the wt % of LMWF in the compositions is greater than the wt % of HMWF. The polyethylene compositions may be suitable for making films, particularly oriented films such as uni axially (machine-direction-oriented) or biaxially-oriented films, and in particular all-PE films.

### RELATED CASES

This Application claims the benefit of U.S. Provisional Application 63/199,128 filed Dec. 8, 2020, entitled “High Density Polyethylene Compositions With Long Chain Branching”, the entirety of which is incorporated by reference herein.

### FIELD

The present disclosure relates to polyolefin compositions, and in particular polyethylene compositions, as well as articles including or made from the compositions.

### BACKGROUND

Polyolefins, such as polyethylenes, having high molecular weight generally have improved mechanical properties over their lower molecular weight counterparts. However, high molecular weight polyolefins can be difficult to process and costly to produce. Polyolefins with lower molecular weights generally have improved processing properties. Polyolefins having a bimodal and/or broad molecular weight distribution, having a high molecular weight fraction (HMWF) and a low molecular weight fraction (LMWF), may be desirable because they can combine the advantageous mechanical properties of the HMWF with the improved processing properties of the LMWF.

It may be desirable to be able to produce multimodal and/or broad molecular weight distribution (MWD) polyolefins, such as multimodal high density polyethylene (HDPE) compositions, for applications including film, pressure pipe, corrugated pipe, and blow molding. Multimodal and/or broad MWD polyolefins ideally should have excellent processability, as evidenced by high melt strength and extrusion high specific throughput with low head pressure, as well as good mechanical properties.

Nonetheless, even with combined strength and processing of bimodal HDPE, challenges remain in incorporating such polyolefins into various applications such as film applications that are increasingly garnering attention. One example is highly oriented films —such as biaxially oriented polyethylene (BOPE) films, which can be used in making all-PE films for greater recyclability (replacing other biaxially oriented films that do not lend themselves to recycling, such as biaxially oriented polypropylene, polyethylene terephthalate, and polyamide (BOPP, BOPET, and BOPA films)). However, improved polyethylene resins are needed in order for BOPE films to compete in performance (e.g., stiffness, thermal resistance, etc.) with BOPP, BOPET, and BOPA films. And while some bimodal HDPE resins could provide the needed strength properties in this space, HDPE resins are generally difficult to incorporate into BOPE films due to their relatively poor orientability (along machine direction (MD) and transverse direction (TD) orientations) and narrow acceptable operating windows (specific and limited stretch ratio, stretching temperature range, line speeds, etc.) required for processing.

There is accordingly a need for new polyolefin compositions, and particularly new polyethylene compositions, that provide suitable strength and other performance properties while still being easy to process, including in highly oriented film structures such as BOPE.

References of potential interest in this regard include: EP 3293208 A1; EP 1330490 B1; US 2001/0014724 A1; EP 2275483 B1; U.S. Pat. No. 6,562,905 B1; U.S. Pat. Nos. 6,185,349; 9,068,033; U.S. patent. Nos. 10,604,643; 10,047,176; US Patent Publication Nos. 2016/0031191; WIPO Publication Nos. WO2015/154253, WO2017/127808, WO2017/184633, WO2018/109112, WO2019/156733, WO2020/001191, WO2020/167498, WO2020/133248; as well as “Biaxially oriented polyethylene films made using a combination of high density polyethylene and low density polyethylene resins,” IP.com (IPCOM000260974D), 13 Jan. 2020; Chen, Q. et al. (2019) “Structure Evolution of Polyethylene in Sequential Biaxial Stretching along the First Tensile Direction,” Ind. Eng. Chem. Res., V. 58, pp. 12419-12430.

### SUMMARY

The present disclosure relates to polyolefin compositions and articles including the polyolefin compositions.

In some embodiments, the polyolefin composition is a high density polyethylene (HDPE) composition having density from about 0.930 or 0.935 to about 0.970 or 0.975 g/cm³, having rather broad molecular weight distributions (e.g., Mw/Mn≥10 and/or Mz/Mn≥80) and a highly branched architecture (e.g., with g′ index (LCB index) less than or equal to 0.85, preferably less than or equal to 0.75 or even 0.70, such as within the range from 0.5 or 0.6 to 0.70, 0.75, or 0.85). The polyethylene composition may furthermore have melt index (MI or I_{2.16}, measured at 190° C., 2.16 kg) within the range from 0.1 to 5.0 (such as 0.2 to 1.0). The polyethylene composition may also include 80 wt % to 99.9 wt % ethylene content and 20 wt % to 0.1 wt % a C₃ to C₄₀ α-olefin comonomer content, based on ethylene content plus comonomer content.

Also contemplated herein are polyethylene compositions having the above noted density, and further characterized by a particular relationship between their molten state rheology and molecular features, captured in the “LOW ratio” defined as the following relationship in (Eqn. 1), so-called because it captures the relationship between (a) low-speed, low-weight rheology and (b) microstructure of the polyethylene composition:

$$\frac{MI {η}_{628}}{{M}_{n} {g}_{LCB}^{′}} \qquad ( Eqn . 1 )$$

where MI is Melt Index and g′_{LCB} is long-chain-branching index (both defined above), η₆₂₈ is the complex viscosity at 628 rad/s (this may also be referred to as η_{low} because at such high shear rates, viscosity is relatively low), and Mn is number-average molecular weight. Polyethylene compositions of various embodiments may have “LOW ratio” of at least 0.020 or at least 0.030, or preferably greater than 0.030, such as within the range from 0.031 to 0.060, more preferably 0.033 to 0.050.

Polyethylene compositions of the present disclosure may also or instead be characterized by a “Broad-High Ratio,” which captures characteristics across the entire breadth of molecular weight by using Mz/Mn and high-load, high-viscosity rheological characteristics, as defined in (Eqn. 2):

$$\frac{Mz * HLMI}{Mn * {g}_{LCB}^{′} * {η}_{0.01}} \qquad ( Eqn . 2 )$$

Polyethylene compositions according to the above and/or further embodiments may also or instead be characterized by having two distinct fractions: a high molecular weight fraction (HMWF) and low molecular weight fraction (LMWF). The HMWF of such embodiments may have 40 wt % to 50 wt %; and the LMWF of such embodiments may have 50 wt % to 60 wt % such as from 52 wt % or 55 wt % to 60 wt % LMWF and from 40 wt % to 45 wt % or 48 wt % HMWF, such as about 55 wt % LMWF and about 45 wt % HMWF.

Yet further embodiments provide an article, and in particular, a highly oriented article (e.g., a film such as a biaxially oriented polyethylene (BOPE) film) made from polyethylene compositions according to various embodiments.

### BRIEF DESCRIPTION OF THE DRAWINGS

FIG. 1a reports the Small Amplitude Oscillatory Shear (SAOS) profiles of some examples of polyethylene compositions in accordance with the present disclosure, as well as SAOS profiles of comparative resins CE1 and CE2.

FIG. 1b reports the SAOS profiles of the same examples of polyethylene compositions, as well as SAOS profiles of comparative resins CE3, CE4, and CE5.

FIG. 2a reports the Gel Permeation Chromatography (GPC) profiles of example polyethylene compositions in accordance with the present disclosure, as well as GPC profiles of comparative resins CE1 and CE2.

FIG. 2b reports the GPC profiles of the same example polyethylene compositions, as well as the GPC profiles of comparative resins CE3, CE4, and CE5.

### DETAILED DESCRIPTION

The present disclosure relates to polyolefin compositions and articles including the polyolefin compositions. The polyolefin compositions of various embodiments are high density polyethylene (HDPE) compositions that exhibit a unique combination of molecular architecture and mechanical signature that make them particularly useful in making highly oriented applications, such as oriented films like MDO and BOPE films. The polyethylene compositions enable superior processing, e.g., through broadening the acceptable operating windows (temperature, line speed, etc.) for oriented film production using the polyethylene compositions. The polyethylene compositions according to some embodiments may be characterized by their broad molecular weight distribution and highly branched architecture. Also or instead, the compositions may be characterized by a LOW Ratio (defined in Eqn. 1 above) within the range from 0.031 to 0.060, such as 0.033 to 0.060, preferably 0.033 to 0.045, capturing their unique combination of rheological behavior (low viscosity at high shear rates) and long-chain branched molecular structure. Increases in either or both of these features are reflected in a higher “LOW Ratio” (g′_{LCB} decreases with greater LCB nature, increasing the LOW Ratio value). The Broad-High Ratio (defined in Eqn. 2 above) may be used in addition to or instead of the LOW Ratio to characterize the polyethylene compositions, to capture the combined Mz and g′_{LCB} quantifications (capturing both LCB and high-molecular-weight chain population of the polyethylene composition). According to yet further aspects of the present disclosure, the polyethylene compositions may also or instead be characterized by their distinct high- and low-molecular weight fractions (HMWF and LMWF). Further, in particular embodiments, all of the above (or sub-sets of the above) may be used in combination to characterize the polyethylene compositions of various embodiments: for instance, polyethylene compositions of some embodiments may exhibit: (1) asymmetric bimodality. Each of these aspects is discussed in turn below, following some pertinent definitions used herein.

### Definitions

The term “polyethylene” refers to a polymer having at least 50 wt % ethylene-derived units, such as at least 70 wt % ethylene-derived units, such as at least 80 wt % ethylene-derived units, such as at least 90 wt % ethylene-derived units, or at least 95 wt % ethylene-derived units, or 100 wt % ethylene-derived units. The polyethylene can thus be a homopolymer or a copolymer, including a terpolymer, having one or more other monomeric units. A polyethylene described herein can, for example, include at least one or more other olefin(s) and/or comonomer(s).

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 50 wt % to 55 wt %, it is understood that the mer unit in the copolymer is derived from ethylene in the polymerization reaction and said derived units are present at 50 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically.

The term “alpha-olefin” or “α-olefin” refers to an olefin having a terminal carbon-to-carbon double bond in the structure thereof R¹R²C≡CH₂, where R¹ and R² can be independently hydrogen or any hydrocarbyl group; such as R¹ is hydrogen and R² is an alkyl group. A “linear alpha-olefin” is an alpha-olefin wherein R¹ is hydrogen and R² is hydrogen or a linear alkyl group.

For the purposes of the present disclosure, ethylene shall be considered an α-olefin.

When a polymer or copolymer is referred to herein as comprising an alpha-olefin (or α-olefin), including, but not limited to ethylene, 1-butene, and 1-hexene, the olefin present in such polymer or copolymer is the polymerized form of the olefin. For example, when a polymer is said to have an “ethylene content” or “ethylene monomer content” of 80 to 99.9 wt %, or to comprise “ethylene-derived units” at 80 to 99.9 wt %, it is understood that the mer unit in the copolymer is derived from ethylene in the polymerization reaction and said derived units are present at 80 to 99.9 wt %, based upon the weight of ethylene content plus comonomer content.

As used herein, and unless otherwise specified, the term “Cₙ” means hydrocarbon(s) having n carbon atom(s) per molecule, wherein n is a positive integer.

### Polyethylene Compositions

Polyethylene compositions of the present disclosure may include copolymers of a C₂ to C₄₀ olefin and one, two or three or more different C₂ to C₄₀ olefins. In particular embodiments, the polyethylene compositions comprise a majority of units derived from polyethylene, and units derived from one or more C₃ to C₄₀ comonomers, preferably C₃ to C₂₀ α-olefin comonomers (e.g., propylene, 1-butene, 1-hexene, 1-octene, 1-decene, 1-dodecene, preferably propylene, 1-butene, 1-hexene, 1-octene, or a mixture thereof; more preferably 1-butene and/or 1-hexene, and in some cases most preferably 1-butene).

The polyethylene composition may comprise the ethylene-derived units in an amount of at least 80 wt %, or 85 wt %, preferably at least 90, 95, 96, 97, 98, 98.5 or 99 wt % (for instance, in a range from a low of 80, 85, 90, 95, 98, 98.5, 98.7, 99.0, 99.1, 99.2, 99.3, or 99.4 wt %, to a high of 96, 97, 98.1, 98, 98.2, 98.3, 98.4, 98.5, 98.6, 98.7, 98.8, 98.9, 99.0, 99.1, 99.2, 99.3, 99.4, 99.5, 99.6, 99.7, 99.8, or 99.9 wt %, with ranges from any foregoing low end to any foregoing high end contemplated, provided the high is greater than the low). For instance, the polyethylene composition may comprise 95, 98, 98.5, 98.7, or 99 wt % to 99.4, 99.5, or 99.6 wt % ethylene-derived units. Comonomer units (e.g., C₂ to C₂₀ α-olefin-derived units, such as units derived from butene, hexene, and/or octane) may be present in the polyethylene composition within the range from a low of 0.1, 0.2, 0.3, 0.4, 0.5, 0.6, 0.7, 0.8, 0.9, 1.0, 2.0, 3.0, 4.0, or 5.0 wt %, to a high of 0.7, 0.8, 0.9, 1, 1.1, 1.2, 1.3, 1.4, 1.5, 1.6, 1.7, 1.8, 1.9, 2, 3, 4, 5, 10, 15, or 20 wt %, with ranges from any foregoing low ends to any foregoing high ends contemplated, provided the high is greater than the low end). For instance, the polyethylene composition may comprise 0.4 or 0.5 wt % to 1.0, 1.3, 1.5, 2.0, or 5.0 wt % comonomer units.

Several suitable comonomers were already noted, although in various embodiments, other α-olefin comonomers are contemplated. For example, the α-olefin comonomer can be linear or branched, and two or more comonomers can be used, if desired. Examples of suitable comonomers include linear C₃-C₂₀ α-olefins (such as butene, hexene, octane as already noted), and α-olefins having one or more C₁-C₃ alkyl branches, or an aryl group. Specific examples include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting. In some embodiments, comonomers include propylene, 1-butene, 1-pentene, 4-methyl-1-pentene, 1-hexene, 1-octene and styrene.

A polyethylene composition according to various embodiments can have a density of 0.930 to 0.975 g/cm³, such as 0.938 to 0.965 g/cm³. For example, ethylene polymers may have a density from a low end of 0.935, 0.940, 0.945, 0.950, 0.953, 0.955, 0.956, or 0.957 g/cm³ to a high end of 0.960, 0.961, 0.962, 0.963, 0.964, 0.965, 0.966, 0.970 or 0.975 g/cm³, with ranges of various embodiments including any combination of any upper or lower value disclosed herein (with density of 0.953 to 0.965, such as 0.955 to 0.963 g/cm³, being of particular interest in some embodiments). Density herein is measured according to ASTM D1505-19 (gradient density) using a density-gradient column on a plaque. The plaque is molded according to ASTM D4703-10a, procedure C, and the plaque is conditioned for at least hours at 23° C. to approach equilibrium crystallinity in accordance with ASTM D618-08.

### Polyethylene Composition—Microstructure (Molecular Characteristics)

In various embodiments, the polyethylene composition has one or more, two or more, or, preferably, all of the following molecular weight properties:
weight-average molecular weight (Mw) within the range generally from 100,000 to 250,000 g/mol; and in particular from a low end of any one of 100,000; 110,000; 120,000; or 130,000 g/mol to a high end of any one of 170,000; 175,000; 180,000; 190,000; 200,000; 225,000; or 250,000 g/mol, with ranges from any foregoing low end to any foregoing high end contemplated (e.g., 120,000 or 130,000 g/mol to 180,000 or 200,000 g/mol).
number-average molecular weight (Mn) generally within the range from 5,000 to 30,000, such as from a low end of any one of 5,000; 6,000; 7,000; 8,000; or 9,000 g/mol to a high end of any one of 11,000; 12,000, 13,000; 14,000; 15,000; 20,000; 25,000; or 30,000 g/mol, with ranges from any foregoing low end to any foregoing high end contemplated (e.g., 8,000 or 9,000 g/mol to 11,000 or 15,000 g/mol).
Z-average molecular weight (Mz) generally within the range from 700,000 to 2,000,000 g/mol; and in particular from a low end of any one of 700,000; 750,000; 800,000; 850,000; and 900,000 g/mol to a high end of any one of 1.2M, 1.3M, 1.4M, 1.5M, 1.6M, 1.7M, 1.8M, 1.9M, or 2.0M g/mol, with ranges from any foregoing low end to any foregoing high end contemplated (e.g., 700,000 g/mol to 1.5M g/mol, such as 800,000 g/mol to 1.2M g/mol). In certain embodiments, Mz may be at least 700,000 g/mol, such as 800,000 g/mol or more; 850,000 g/mol or more; or 900,000 g/mol or more, with no upper limit necessarily contemplated or required.

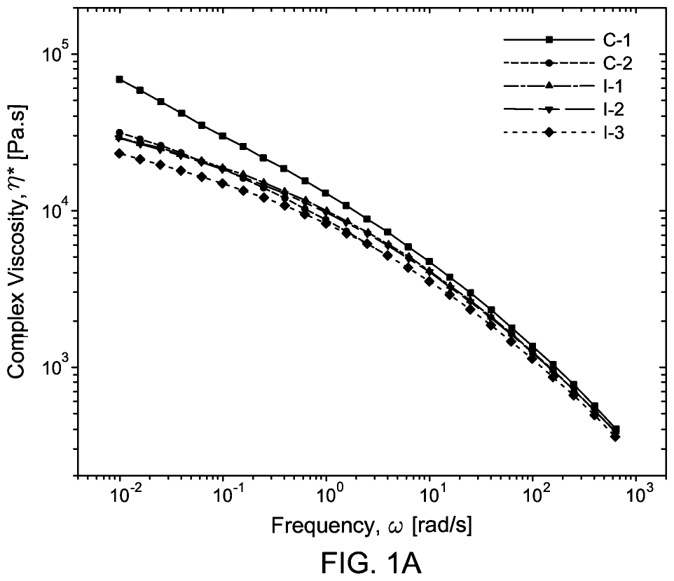

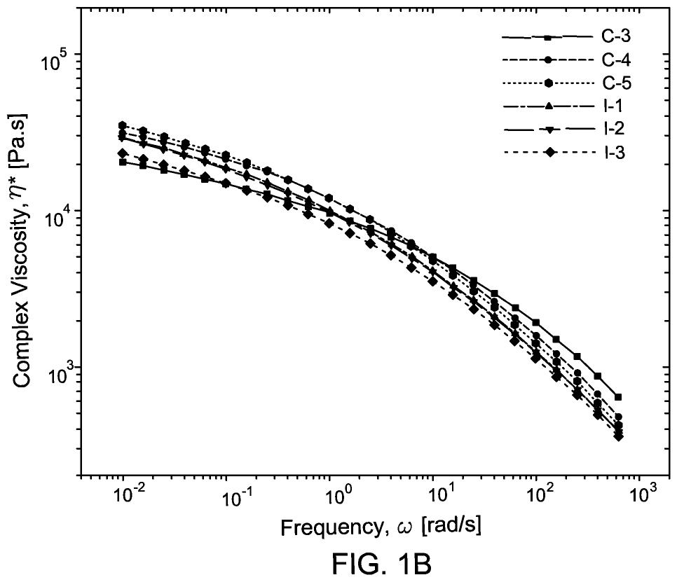

Polyethylene compositions according to various embodiments herein preferably include a high-molecular weight and a low-molecular weight fraction, and may exhibit multimodal (such as bimodal) distribution in a GPC analysis of molecular weight distributions, meaning that there are multiple (such as 2, 3, or more; preferably 2) distinguishable peaks in a molecular weight distribution curve of the composition (as determined using gel permeation chromatography (GPC) or other recognized analytical technique, noting that if there is any conflict between or among analytical techniques, a molecular weight distribution determined by GPC, as described below, shall control). Examples of “unimodal” molecular weight distribution can be seen in U.S. Pat. No. 8,691,715, FIG. 6 of such patent, which is incorporated herein by reference. This is in contrast with a “multimodal” molecular weight distribution (again, as determined by GPC or any other recognized analytical technique, with GPC controlling in the event of any conflict). For example, if there are two distinguishable peaks in the molecular weight distribution curve such composition may be referred to as bimodal composition. For example, in the ′715 Patent, FIGS. 1-5 of that Patent illustrate representative bimodal molecular weight distribution curves. In these figures, there is a valley between the peaks, and the peaks can be separated or deconvoluted.

With such modality in mind, the polyethylene compositions of various embodiments may exhibit Mw/Mn ratio (sometimes referred to as polydispersity index, PDI, or as the quantification of molecular weight distribution, MWD) of 10 or more, preferably 12 or more, such as within the range from 10, 11, or 12 to 15, 16, 17, 20, 22, or 25, with ranges from any foregoing low end to any foregoing high end also contemplated (e.g., 11 to 20 or 12 to 17). Mz/Mn ratio (indicating the broadness of the overall distribution of molecular weights among chains within the polymer by considering the two characteristic values of very high molecular-weight chains (Mz) and very low molecular-weight chains (Mn)) is at least 70, such as 75 or more, or more preferably 85 or more. In certain embodiments, Mz/Mn may be within the range from a low of any one of 70, 75, 80, 81, 82, 83, 84, or 85 to a high of any one of 100, 105, 110, 115, 120, 125, or 130, with ranges from any low end to any high end contemplated (e.g., 75 to 110, or 80 to 100). Further, the polyethylene compositions may have Mz/Mw within the range from 4, 5, or 6 to 8, 9, 10, 12, or 15 (also with ranges from any low to any high contemplated).

Polyethylene compositions in accordance with various embodiments also exhibit a substantial degree of long chain branching, and therefore can have a g′ value (also referred to as g′vis, g′_{LCB}, branching index, or long chain branching (LCB) index) less than or equal to 0.85, preferably less than or equal to 0.75 or even 0.70. For instance, g′_{LCB} may be within the range from a low of any one of 0.50, 0.55, 0.60 or 0.65 to a high of 0.69, 0.70, 0.71, 0.73, 0.75, 0.80, or 0.85 (with ranges from any foregoing low to any foregoing high contemplated, such as 0.50 to 0.80 or 0.55 to 0.75).

The distribution and the moments of molecular weight (Mw, Mn, Mz, Mw/Mn, Mz/Mn, etc.), the monomer/comonomer content (C₂, C₄, C₆ and/or C₈, and/or others, etc.) and the long chain branching indices (g′) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLge1 10 μm Mixed-B LS columns are used to provide polymer separation.

Detailed analytical principles and methods for molecular weight determinations are described in paragraphs [0044]-[0051] of PCT Publication WO2019/246069A1, which are herein incorporated by reference (noting that the equation c=///referenced in Paragraph [0044] therein for concentration (c) at each point in the chromatogram, is c=βI, where β is mass constant and I is the baseline-subtracted IR5 broadband signal intensity (I)). Unless specifically mentioned, all the molecular weight moments used or mentioned in the present disclosure are determined according to the conventional molecular weight (IR molecular weight) determination methods (e.g., as referenced in Paragraphs [0044]-[0045] of the just-noted publication), noting that for the equation in such Paragraph [0044], α=0.695 and K=0.000579(1-0.75 Wt) are used, where Wt is the weight fraction for hexane comonomer, and further noting that comonomer composition is determined by the ratio of the IR5 detector intensity corresponding to CH₂ and CH₃ channel calibrated with a series of PE and PP homo/copolymer standards whose nominal values are predetermined by NMR or FTIR (providing methyls per 1000 total carbons (CH₃/1000 TC)) as noted in Paragraph [0045] of the just-noted PCT publication).

On the other hand, light scattering (LS) is used to determine branching index g′LCB (also referred to as g′ᵥᵢₛ), in accordance with the methods described in Paragraphs [0048]-[0051] of PCT Publication WO2019/246069A1, with the following clarifications: when determining optical constant Kₒ per Paragraph [0048] of that reference, dn/dc=0.1048 ml/mg and A₂=0.0015 for any ethylene copolymer other than ethylene-butene, ethylene-hexene, and ethylene-octene copolymers; furthermore, My (used for determining g′LCB per Paragraph [0051] of the WO'069 publication) is the viscosity-average molecular weight determined by LS analysis; and finally, also in the g′_{LCB} determination, K=0.0005 and α=0.695 for all ethylene copolymers other than the ethylene-butene, ethylene-hexene, and ethylene-octene copolymers specifically noted in the WO'069 publication. Note also that Mn is sensitive to the low molecular tail which is influenced by smaller molecules as oligomers. On the other hand, Mw and Mz are significantly less sensitive. However, for all samples, the GPC range was selected between Log MW (g/mol) of 2.6-2.7 (low molecular weight limit) and Log MW of 6.9-7.0 (high molecular weight limit).

Rheological Properties

In various embodiments, the polyethylene compositions have melt index, (MI, also referred to as I₂ or I_{2.16} in recognition of the 2.16 kg loading used in the test) within the range from 0.1 g/10 min to 5 g/10 min, such as from a low of any one of 0.1, 0.3, 0.5, and 0.6 g/10 min, to a high of any one of 0.85, 0.90, 0.95, 1.0, 1.5, 2.0, 3.0, 4.0, or 5.0 g/10 min, with ranges from any of the foregoing low ends to any of the foregoing high ends contemplated herein) (e.g., 0.1 to 1.0 g/10 min, such as 0.6 to 0.9 g/10 min). Moreover, polyethylene compositions of various embodiments can have a high load melt index (HLMI) (also referred to as 121 or 121.6 in recognition of the 21.6 kg loading used in the test) within the range from a low of 25, 30, 35, 40, 45, 46, 47, 48, 49, or 50 g/10 min to a high of any one of 60, 65, 70, 75, 80, 85, or 90 g/10 is min; with ranges from any of the foregoing lows to any of the foregoing highs contemplated herein (e.g., 40 to 80 g/10 min, such as 45 to 65 g/10 min).

Polyethylene compositions according to various embodiments may have a melt index ratio (MIR, defined as I_{21.6}/I_{2.16} or HLMI/MI) within the range from a low of any one of 30, 35, 40, 45, 50, 55, 60, 65, 66, 67, 68, 69, or 70 to a high of any one of 80, 81, 82, 83, 84, 85, 90, 95, 100, 110, 120, 130, 140, or 150; with ranges from any of the foregoing lows to any of the foregoing highs contemplated herein (e.g., 30 to 140, 50 to 100, 65 to 90, 70 to 85, etc.).

Melt index (2.16 kg) and high-load melt index (HLMI, 21.6 kg) values can be determined according to ASTM D1238-13 procedure B, such as by using a Gottfert MI-2 series melt flow indexer. For MI, HLMI, and MIR values reported herein, testing conditions were set at 190° C. and 2.16 kg (MI) and 21.6 kg (HMLI) load.

In various embodiments, the polyethylene composition exhibits shear-thinning rheology, meaning that for increasing shear rates, viscosity decreases. This rheology indicates good processability for the polyethylene compositions in accordance with such embodiments (insofar as the shear rates simulate the viscosity that the composition may exhibit when processed in extruders or similar equipment). Accordingly, a polyethylene composition according to various embodiments may exhibit one or more, preferably two or more, or even all, of the following rheological properties:
Degree of shear thinning, DST, within the range from a low of 0.920, 0.925, 0.930, 0.935, or 0.940 to a high of 0.950, 0.955, 0.960, 0.965, 0.970, 0.980, 0.985, or 0.990, with ranges from any foregoing low to any foregoing high contemplated herein (e.g., 0.920 to 0.970, such as 0.940 to 0.960). DST is a measure of shear-thinning rheological behavior (decreasing viscosity with increasing shear rate), defined as DST=[η*(0.01 rad/s)−η*(100 rad/s)]/η*(0.01 rad/s), where η*(0.01 rad/s) and η*(100 rad/s) are the complex viscosities at 0.01 and 100 rad/s, respectively.
Complex viscosity (at 628 rad/s, 190° C.) of 800, 700, 600, 500, 450, or 400 Pa*s or less; such as within the range from a low of 200, 250, 300, 325, or 350 Pa*s to a high of 400, 450, 500, 550, 600, 650, 700, 750, or 800 Pa*s, with ranges from any of the foregoing low ends to any of the foregoing high ends contemplated in various embodiments (provided the high end is greater than the low end) (e.g., 200 to 400 Pa*s, such as 300 to 400 Pa*s).
Complex viscosity (at 100 rad/s, 190° C.) of 3,000 Pa*s or less, such as 2,000 Pa*s or less; such as within the range from a low of any one of 700; 800; 900; 1000; or 1,100 Pa*s to a high of any one of 1,200; 1,300; 1,400, 1,500; 1,600; 1,700; 1,800; 1,900; or 2,000 Pa*s, with ranges from any foregoing low to any foregoing high contemplated (e.g., 700 to 2,000 Pa*s, such as 1,000 to 1,300 Pa*s).
Complex viscosity (at 0.01 rad/s, 190° C.) of 50,000 Pa*s or less; such as 40,000 Pa*s or less; or 35,000 Pa*s or less; or in some cases within the range from a low of 10,000; 15,000; 20,000; or 25,000 Pa*s to a high of 30,000; 35,000; 40,000; 45,000; or 50,000 Pa*s, with ranges from any low end to any high end contemplated herein (e.g., 10,000 to 50,000 Pa*s, such as 15,000 to 40,000 Pa*s or 20,000 to 35,000 Pa*s).

Rheological data such as complex viscosity was determined using SAOS (small amplitude oscillatory shear) testing. SAOS experiments were performed at 190° C. using a 25 mm parallel plate configuration on an ARES-G2 (TA Instruments). Sample test disks (25 mm diameter, 2 mm thickness) were made with a Carver Laboratory press at 190° C. Samples were allowed to sit without pressure for approximately 3 minutes in order to melt and then held under pressure typically for 3 minutes to compression mold the sample. The disk sample was first equilibrated at 190° C. for about 5 minutes between the parallel plates in the rheometer to erase any prior thermal and crystallization history. An angular frequency sweep was next performed with a typical measurement gap of 1.5 mm from 628 rad/s to 0.01 rad/s angular frequency using 5 points/decade and a strain value within the linear viscoelastic region determined from strain sweep experiments (see C. W. Macosko, Rheology Principles, Measurements and Applications, Wiley-VCH, New York, 1994). All experiments were performed in a nitrogen atmosphere to minimize any degradation of the sample during the rheological testing.

Furthermore, the polyethylene composition may also or instead have tan(6) value indicative of moderate long chain branching (LCB); and in particular tan(6) within the range from a low of 1.5, 2, 3, 3.5, or 4.0 to a high of 4.5, 5.0, 5.5, 6.0, or 6.5 (with ranges from any low end to any high end contemplated). As used herein, tan(6) is measured using dynamic shear rheometry with a discrete data point taken at frequency of 0.01585 rad/s, with test conditions being: temperature of 190° C. and stress amplitude of 200 Pa.

### Microstructure and Rheology Relationships

As noted previously, polyethylene compositions according to various embodiments may exhibit one or more of the above properties, and in particular one or more of the microstructure properties and one or more of the rheological properties. In addition, such polyethylene compositions may be characterized by a combination of microstructure and rheology by any of various means.

For instance, polyethylene compositions of various embodiments exhibit a “LOW Ratio” defined as the following relationship in (Eqn. 1), so-called because it captures the relationship between (1) low-speed, low-weight rheology and (2) microstructure of the polyethylene composition:

$$\frac{MI {η}_{628}}{{M}_{n} {g}_{LCB}^{′}} \qquad ( Eqn . 1 )$$

where MI is Melt Index (I_{2.16} at 190° C., in g/10 min) and g′_{LCB} is long-chain-branching index (unitless), I₆₂₈ is the complex viscosity in Pa*s at 628 rad/s (this may also be referred to as η_{low} because at such high shear rates the polyethylene composition exhibits relatively low viscosity), and Mn is number-average molecular weight in g/mol. The ratio as defined should be considered as akin to an index and therefore is unitless for purposes of the present disclosure. Polyethylene compositions of various embodiments may have “LOW ratio” of at least 0.02 or at least 0.03, preferably greater than 0.030, such as within the range from a low of any one of 0.031, 0.032, or 0.033 to a high of any one of 0.050, 0.10, 0.20, 0.30, 0.40, 0.50, or 0.60, with ranges from any foregoing low end to any foregoing high end also contemplated (e.g., within the range from a low of 0.030, 0.031, or 0.032, to a high of 0.050, or 0.50, or 0.60).

Also or instead, the concept can be expanded to capture the characteristics across the entire breadth of molecular weight by using Mz/Mn and high-load, high-viscosity rheological characteristics, by defining a “Broad-High Ratio” as follows:

$$\frac{Mz * HLMI}{Mn * {g}_{LCB}^{′} * {η}_{0.01}} \qquad ( Eqn . 2 )$$

where Mz and Mn are z- and n- average molecular weights (g/mol); HLMI is high load melt index (I₂₁0.6, at 190° C.) in g/10 min; η_{0.01} is the complex viscosity at 0.01 rad/s (in Pa*s); and g′LCB is the LCB index (unitless). As with the “LOW Ratio”, the end value is considered akin to an index and therefore is unitless for purposes of the present disclosure. Polyethylene compositions of various embodiments may have “Broad-High Ratio” of at least 0.15, preferably at least 0.20, such as within the range from a low of any one of 0.15, 0.20, or 0.21 to a high of any one of 0.40, 0.45, 0.50, 0.60, 0.70, 1.0, 2.0, 3.0, 4.0, 5.0, 5.5, or 6.0 (with ranges from any foregoing low to any foregoing high contemplated, such as 0.20 to 0.70, 1.0, 2.0, 3.0, or 6.0). This may be instead of or, preferably, in addition to the LOW Ratio values noted previously.

### Fractions of the Polyethylene Compositions

A polyethylene composition according to any of the various embodiments herein can have a low molecular weight fraction, LMWF, and a high molecular weight fraction, is HMWF. For example, a polyethylene composition may comprise from 0.1 to 99.9 wt % of the LMWF, with the balance composed of the HMWF (where wt % are on the basis of total polymer, such that LMWF+HMWF=100%). For instance, polyethylene composition may comprise from 30 to 70 wt % LMWF, such as from 40 to 60 wt % LMWF, or 40 to 50 wt % or even 45 to 55 wt % LMWF (with HMWF forming the balance in each instance).

In some preferred embodiments, the polyethylene composition may comprise more LMWF than HMWF. For example, the polyethylene composition may comprise HMWF in an amount ranging from a low end of about 40, 41, 42 or 43 wt %, to a high of 47, 48, 49, or 49.9 wt % (with ranges from any foregoing low to any foregoing high contemplated herein), with the balance being LMWF. For instance, some embodiments may include 40-49.9, 41-49, or 42-47 wt % HMWF and, respectively, 50.1-60, 51-59, or 53-58 wt % LMWF.

As discussed below, many embodiments include polyethylene compositions made in multiple (2 or more, preferably 2 according to some embodiments) polymerization reaction zones in series. In particular of these embodiments, the LMWF is made in the first series reaction zone, then LMWF is introduced into the second series reaction zone, downstream of the first, to produce a polyethylene composition (comprising the HMWF formed in the second reaction zone, in combination with the LMWF, e.g., that remains unreacted, present). For such embodiments, properties of the LMWF may be determined directly (e.g., by sampling some portion of polymer product taken from the first reactor, and/or isolated from the end product). The property or properties of the polyethylene composition can likewise be determined directly.

Alternatively, in embodiments in which LMWF and HMWF are produced in parallel reactors and then post-reactor blended, properties of both the LMWF and HMWF (as well as the final post-blend polymer composition) can be determined directly.

In certain embodiments, the LMWF may be an ethylene homopolymer (e.g., the LMWF may be obtained by polymerizing ethylene in the first reaction zone without addition of comonomer), and the HMWF may be a copolymer, such as an ethylene-butene or ethylene-hexene copolymer. The HMWF in such embodiments may be the polymerization product resulting from feeding comonomer with ethylene and/or LMWF product (in series reaction embodiments) in a comonomer/ethylene ratio within the range from 0.25 or 0.5 to 2.0 or 2.5% (on the basis of moles comonomer/moles ethylene, such that 2.5% means 2.5 moles comonomer per 100 moles ethylene).

Thus, in some embodiments, the HMWF of a polyethylene composition has a lower density than the LMWF of the polyethylene composition. In other words, an LMWF of a polyethylene composition can have a higher density than an HMWF of the polyethylene composition.

### Methods of Making Polyethylene Compositions

In some embodiments, a single site catalyst may be fed in staged reactors. Ethylene and optionally an α-Olefin comonomer (such as C₃-C₁₀ α-Olefin, such as 1-butene) may be used to adjust density of the resulting polyethylene composition. Gas phase reactors, slurry loop reactors, solution process or CSTR in series or any combination thereof may be used to produce the polyethylene compositions. The HMWF may be produced in either the first or the second reactor. Likewise, the LMWF may be produced in either the first or the second reactor, where the LMWF is produced in a different reactor than the HMWF. Any suitable Ziegler-Natta catalyst can be used to produce the LMWF and/or the HMWF. In some particular embodiments, the LMWF is produced in the first series reactor, and the HMWF is produced in the second series reactor, downstream of the first.

As a more specific example, in some embodiments, the LMWF is formed in a first reactor (of a series of reactors). LMWF, catalyst, unreacted monomer, diluent, and hydrogen are fed from the outlet of the first reactor to a flash tank where the hydrogen and unreacted monomer are removed. The LMWF granules containing active catalyst are fed from the flash tank into a second series reactor. Monomer and hydrogen, (optional comonomer), and solvent are added to the second reactor. In some embodiments, no new catalyst need be fed to the second reactor.

In general, any suitable polymerization process may be employed to arrive at the polyethylene compositions according to various embodiments. For instance, U.S. patent. Nos. 10,604,643 and 10,047,176 describe cascading slurry loop polymerization reactors in series for production of bimodal HDPE; such processes in general are suitable for producing the presently disclosed polyethylene compositions, noting however that a particularly high pressure in the first series reactor (e.g., 8-9 bar) for producing the LMWF may be preferred in accordance with present embodiments. Furthermore, in the context of such series slurry loop polymerizations, hydrogen may be used in both series reactors, e.g., to control molecular weight. According to particular embodiments herein, the first reactor (LMWF reactor in particular embodiments) may be provided with hydrogen such that the ratio of hydrogen to ethylene as measured in the reactor is within the range from 2 to 7 mol hydrogen to mol ethylene (e.g., 2 to 5 mol H₂/mol ethylene; or 3 to 4 mol H₂/mol ethylene). The second reactor (HMWF reactor in particular embodiments) may be provided with hydrogen such that the ratio of hydrogen to ethylene as measured in the reactor is within the range from 0.05 to 1 mol hydrogen per mol ethylene (e.g., 0.1 to 0.5 mol H₂/mol ethylene, or 0.1 to 0.3 mol H₂/mol ethylene). Furthermore, according to certain embodiments, preferably 2 series reactors (not 3 or more) are used. Finally, branching content is preferably controlled at least in part by post-reactor modification of polyethylene granules recovered from the polymerization reaction, for instance post-reactor air and/or oxygen injection (e.g., injecting air into a mixer with solid polyethylene product, at a flow rate such that about 0.1 to 0.5 lb air is injected per lb solid polyethylene product).

Other potentially suitable processes for series reaction are described, e.g., in U.S. Pat. No. 6,185,349, wherein the polymerization is described as a slurry loop polymerization followed by a gas-phase polymerization reaction in series, although it is noted in this regard that U.S. Pat. No. 6,185,349 describes substantially lower H₂ feed into the LMWF (1^{st} series) reactor than the embodiments contemplated herein (e.g., 200-800 moles H₂ per 1000 moles ethylene, or a mole ratio of 0.2 to 0.8).

In general, references herein to a first and second “reactor,” unless specifically noted otherwise, can equivalently mean to a “reaction zone” (for instance, a discrete portion within a reactor vessel), such that a single reactor vessel could contain multiple reactor zones. Similarly, a “reactor” or reaction zone can in principle include multiple parallel reactor vessels (e.g., such that instead of a “first reactor” being a single vessel, it could equivalently include two, three, or more parallel reactors into which polymerization feed components are split, and polymerization is carried out under identical conditions). The products (including LMWF) can be combined together and fed on to the second series reactor or reaction zone (which itself may include multiple parallel reactor vessels operating under substantially similar conditions); or, the products can remain in parallel and be fed to respective second reactor vessels operating under substantially identical conditions, with final product from the multiple second reactor vessels combined.

After the polymerization process, suitable finishing processes as are known may be employed. For example, in slurry processes, the resulting slurry is separated from the diluent and dried. From there, the polymer is sent to the finishing section. Antioxidant and neutralizing additives may be added to the product as the granules are finished into a final pelletized form.

Alternatively, the LMWF and HMWF are formed in parallel reactors or reaction zones, followed by post-reactor blending the LMWF and HMWF in any suitable post-reactor blending process. Preferably, however, the LMWF and HMWF are formed in series reactors as described above.

Polymerizations can be performed using a catalyst system including a Ziegler-Natta catalyst, a co-catalyst, and optionally a support material.

### Ziegler-Natta Catalysts

The catalyst, for example, may include any Ziegler-Natta (ZN) transition metal catalyst, such as those catalysts disclosed in Ziegler Catalysts 363-386 (G. Fink, R. Mulhaupt and H. H. Brintzinger, eds., Springer-Verlag 1995); or in EP 103 120; EP 102 503; EP 0 231 102; EP 0 703 246; RE 33,683; U.S. Pat. Nos. 4,302,565; 5,518,973; 5,525,678; 5,288,933; 5,290,745; 5,093,415 and 6,562,905. Other examples of ZN catalysts are discussed in U.S. Pat. Nos. 4,115,639; 4,077,904; 4,482,687; 4,564,605; 4,721,763; 4,879,359 and 4,960,741. In general, ZN catalysts include transition metal compounds from Groups 3 to 17, or Groups 4 to 12, or Groups 4 to 6 of the Periodic Table of Elements. As used herein, reference to the Periodic Table of the Elements and groups thereof is to the NEW NOTATION published in Hawley's Condensed Chemical Dictionary, Thirteenth Edition, John Wiley & Sons, Inc., (1997), unless reference is made to the Previous IUPAC form denoted with Roman numerals (also appearing in the same), or unless otherwise noted. Examples of such catalysts include those comprising Group 4, 5 or 6 transition metal oxides, alkoxides and halides, or oxides, alkoxides and halide compounds of titanium, zirconium or vanadium; optionally in combination with a magnesium compound, internal and/or external electron donors (alcohols, ethers, siloxanes, etc.), aluminum or boron alkyl and alkyl halides, and inorganic oxide supports.

ZN catalysts may be represented by the formula: MRx, where M is a metal from Groups 3 to 17, such as Groups 4 to 6, such as Group 4, such as titanium; R is a halogen or a hydrocarbyloxy group; and x is the valence of the metal M. Non-limiting examples of R include alkoxy, phenoxy, bromide, chloride and fluoride.

In a class of embodiments, the ZN catalysts may include at least one titanium compound having the formula Ti(OR)ₐX_{b}, wherein R is a substituted or unsubstituted hydrocarbyl group, such as a C₁ to C₂₅ aliphatic or aromatic group; X is selected from Cl, Br, I, and combinations thereof; a is selected from 0, 1 and 2; b is selected from 1, 2, 3, and 4; and a+b=3 or 4. As used herein, “hydrocarbyl” refers to a moiety comprising hydrogen and carbon atoms.

Non-limiting examples where M is titanium include TiCl₃, TiCl₄, TiBr₄, Ti(OCH₃)Cl₃, Ti(OC₂H₅)₃Cl, Ti(C₂H₅)Cl₃, Ti(OC₄H₉)₃Cl, Ti(OC₃H₇)₂Cl₂, Ti(OC₂H₅)₂Br₂, Ti(OC₆H₅)Cl₂, Ti(OCOCH₃)Cl₃, Ti(OCOC₆H₅)Cl₃, TiCl₃/3AlCl₃, Ti(OC₁₂H₂₅)Cl₃, and combinations thereof.

In a class of embodiments, the ZN catalysts may include at least one magnesium compound. The at least one magnesium compound may have the formula MgX₂, wherein X is selected from the group consisting of C₁, Br, I, and combinations thereof. The at least one magnesium compound may be selected from: MgCl₂, MgBr₂ and MgI₂. ZN catalysts based on magnesium/titanium electron-donor complexes are described in, for example, U.S. Pat. Nos. 4,302,565 and 4,302,566. ZN catalysts derived from Mg/Ti/C₁/THF are also contemplated.

In at least one embodiment, a ZN catalyst is titanium chloride on Magnesium chloride support. Further, a co-catalyst (also known as an activator or modifier, e.g., alkyl aluminum compounds) may be employed with the ZN catalyst in accordance with known polymerization catalyzation techniques, forming a catalyst system. The catalyst system may further be supported, also in accordance with known techniques. Commercial supports include the ES70 and ES757 family of silicas available from PQ Corporation, Malvern, Pa. Other commercial supports include Sylopol™ Silica Supports including 955 silica and 2408 silica available from Grace Catalyst Technologies, Columbia, Md.

Still other suitable ZN catalysts, and co-catalysts to be used therewith, are disclosed in U.S. Pat. Nos. 4,124,532; 4,302,565; 4,302,566; 4,376,062; 4,379,758; 5,066,737; 5,763,723; 5,849,655; 5,852,144; 5,854,164 and 5,869,585 and published EP-A2 0 416 815 A2 and EP-A1 0 420 436. Additional co-catalysts may be found in U.S. Pat. Nos. 3,221,002 and 5,093,415. Furthermore, examples of supporting a catalyst system are described in U.S. Pat. Nos. 4,701,432; 4,808,561; 4,912,075; 4,925,821; 4,937,217; 5,008,228; 5,238,892; 5,240,894; 5,332,706; 5,346,925; 5,422,325; 5,466,649; 5,466,766; 5,468,702; 5,529,965; 5,554,704; 5,629,253; 5,639,835; 5,625,015; 5,643,847; 5,665,665; 5,468,702; and 6,090,740; and PCT Publication Nos. WO 95/32995; WO 95/14044; WO 96/06187; and WO 97/02297.

### Polymer Blends

In another embodiment, the polyethylene composition produced herein is combined with one or more additional polymers in a blend prior to being formed into a film, molded part, or other article. As used herein, a “blend” may refer to a dry or extruder blend of two or more different polymers, and in-reactor blends, including blends arising from the use of multi or mixed catalyst systems in a single reactor zone, and blends that result from the use of one or more catalysts in one or more reactors under the same or different conditions (e.g., a blend resulting from in series reactors (the same or different) each running under different conditions and/or with different catalysts).

Additional polymer(s) can include polyethylene, isotactic polypropylene, highly isotactic polypropylene, syndiotactic polypropylene, random copolymer of propylene and is ethylene, and/or butene, and/or hexene, polybutene, ethylene vinyl acetate, low density polyethylene (LDPE), linear low density polyethylene (LLDPE), high density polyethylene (HDPE), ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, ethylene propylene diene monomer (EPDM) polymer, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In some embodiments, the additional polymer or polymers is/are present in the above blends, at from 0.1 to 99 wt %, based upon the weight of the polymers in the blend, such as 0.1 to 60 wt %, such as 0.1 to 50 wt %, such as 1 wt % to 40 wt %, such as 1 to 30 wt %, such as 1 to 20 wt %, such as 1 to 10 wt %, with the remainder being the polyethylene composition in accordance with the above description.

The blends described above may be produced by mixing the polyethylene composition with one or more additional polymers (as just described above), by connecting reactors together in series to make reactor blends or by using more than one catalyst in the same reactor to produce multiple species of polymer. The polymers can also or instead be mixed together as a post-reactor blend, e.g., prior to being put into an extruder, or may be mixed in an extruder.

The blends may be formed using conventional equipment and processes, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder.

### Additives

Additives may be included in the polyethylene composition and/or in a blend comprising the polyethylene composition (such as those described above), in one or more components of the blend, and/or in a product formed from the polyethylene composition and/or blend, such as a film, as desired. Such additives may include, for example: fillers; neutralizers is (e.g., zinc oxide); antioxidants (e.g., hindered phenolics such as IRGANOX™ 1010 or IRGANOX™ 1076 available from Ciba-Geigy); phosphites (e.g., IRGAFOS™ 168 available from Ciba-Geigy); acid scavenger; processing oils (or other solvents); compatibilizing agents; lubricants (e.g., oleamide); anti-cling additives; tackifiers, such as polybutenes, terpene resins, aliphatic and aromatic hydrocarbon resins, alkali metal and glycerol stearates, and hydrogenated resins; UV stabilizers; heat stabilizers; anti-blocking agents; release agents; anti-static agents; pigments; colorants; dyes; waxes; silica; fillers; talc; and the like.

A polyethylene composition of the present disclosure can include additives such that the additives (e.g., fillers present in a composition) have an average agglomerate size of less than 50 microns, such as less than 40 microns, such as less than 30 microns, such as less than 20 microns, such as less than 10 microns, such as less than 5 microns, such as less than 1 micron, such as less than 0.5 microns, such as less than 0.1 microns, based on a 1 cm×1 cm cross section of a ring polymer composition as observed using scanning electron microscopy.

In at least one embodiment, a polyethylene composition may include fillers and coloring agents. Exemplary materials include inorganic fillers such as calcium carbonate, clays, silica, talc, titanium dioxide or carbon black. Any suitable type of carbon black can be used, such as channel blacks, furnace blacks, thermal blacks, acetylene black, lamp black and the like.

In at least one embodiment, a polyethylene composition may include flame retardants, such as calcium carbonate, inorganic clays containing water of hydration such as aluminum trihydroxides (“ATH”) or magnesium hydroxide.

In at least one embodiment, a polyethylene composition may include UV stabilizers, such as titanium dioxide or Tinuvin® XT-850. The UV stabilizers may be introduced into a roofing composition as part of a masterbatch. For example, UV stabilizer may be pre-blended into a masterbatch with a thermoplastic resin, such as polypropylene, or a polyethylene, such as linear low density polyethylene.

Still other additives may include antioxidant and/or thermal stabilizers. In at least one embodiment, processing and/or field thermal stabilizers may include IRGANOX® B-225 and/or IRGANOX® 1010 available from BASF.

In at least one embodiment, a polyethylene composition may include a polymeric processing additive. The processing additive may be a polymeric resin that has a very high melt flow index. These polymeric resins can include both linear and/or branched polymers that is can have a melt flow rate that is about 500 dg/min or more, such as about 750 dg/min or more, such as about 1000 dg/min or more, such as about 1200 dg/min or more, such as about 1500 dg/min or more. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives can include polypropylene homopolymer, and branched polymeric processing additives can include diene-modified polypropylene polymers. Similar processing additives are disclosed in U.S. Pat. No. 6,451,915, which is incorporated herein by reference.

In some embodiments, fillers (such as calcium carbonate, clays, silica, talc, titanium dioxide, carbon black, a nucleating agent, mica, wood flour, and the like, and blends thereof, as well as inorganic and organic nanoscopic fillers) can be present in a polyethylene composition in an amount from about 0.1 wt % to about 10 wt %, such as from about 1 wt % to about 7 wt %, such as from about 2 wt % to about 5 wt %, based on the total weight of the polyethylene composition. The amount of filler that can be used can depend, at least in part, upon the type of filler and the amount of extender oil that is used.

In some embodiments, and when employed, the polyethylene composition can include a processing additive (e.g., a polymeric processing additive) in an amount of from about 0.1 wt % to about 20 wt % based on the total weight of the polyethylene composition.

### Films and Other End Uses

A polyethylene composition of the present disclosure can be useful in such forming operations as film, sheet, and fiber extrusion and co-extrusion as well as blow molding, injection molding, and rotary molding. Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and non-food contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

The polyethylene compositions may be formed into monolayer or multilayer films. These films may be formed by any of the conventional techniques including extrusion, co-extrusion, extrusion coating, lamination, blowing and casting. The film may be obtained by the flat film or tubular process which may be followed by orientation in a uniaxial direction or in two mutually perpendicular directions in the plane of the film. One or more of the layers of the film may be oriented in the transverse and/or longitudinal directions to the same or different extents. This orientation may occur before or after the individual layers are brought together.

As noted, polyethylene compositions of the present disclosure may be particularly useful in making oriented PE film structures, such as uniaxially oriented (machine direction orientation, MDO) and biaxially oriented PE (BOPE) films. Such films may advantageously be prepared using all-PE structures and formulations (e.g., without PET and other components that are difficult to recycle), given their advantaged strength and other properties.

Methods of producing a biaxially-oriented polyethylene film can comprise: producing a polymer melt comprising a polyethylene composition described herein; extruding a film from the polymer melt; stretching the film in a machine direction at a temperature below the melting temperature of the polyethylene to produce a machine direction oriented (MDO) polyethylene film; and stretching the MDO polyethylene film in a transverse direction to produce the biaxially-oriented polyethylene film.

Stretching in the machine direction can be achieved by threading the film through a series of rollers where the temperature and speed of the individual rollers are controlled to achieve a desired film thickness and the stretch ratio of MD stretching. Typically, this series of rollers are called MDO rollers or part of the MDO stage of the film production. Examples of MDO may include, but are not limited to, pre-heat rollers, various stretching stages with or without annealing rollers between stages, one or more conditioning and annealing rollers, and one or more chill rollers. Stretching of the film in the MDO stage is accomplished by inducing a speed differential between two or more adjacent rollers.

The stretch ratio for MD stretching can be used to describe the degree of stretching of the film. The stretch ratio is the speed of the fast roller divided by the speed of the slow roller. For example, stretching a film using an apparatus where the slow roller speed is 1 m/min and fast roller speed is 7 m/min means the stretch ratio was 7 (also referred to herein as 7 times or 7×). The physical amount of stretching of the film is close to but not exactly the stretch ratio because relaxation of the film can occur after stretching.

Greater stretch ratios for MD stretching result in thinner films with greater orientation in the MD. The stretch ratio in the machine direction can be 1× to 10× (or 3× to 7×, or 5× to 9×, or 7× to 10×). One skilled in the art without undo experimentation can determine suitable temperatures and roller speeds for each roller in a given MDO stage of film production for producing the desired stretch ratios.

Stretching in the transverse direction can be achieved by pulling the film from the edges in a tenter frame, which is a series of mobile clips, as the film passes through a stretching zone of a TDO stage oven. The TDO stage oven typically has three zones: (1) a preheat zone that softens the film, (2) a stretch zone that stretches the film in the transverse direction, and (3) an annealing zone where the stretched film cools and relaxes.

The stretch ratio for TD stretching can be used to describe the degree of stretching of the film using the tenter frame (as compared to the roller speeds when stretching in the MD). The stretch ratio for TD stretching is increase in width of the tenter from beginning to end of stretching and calculated as end-stretched tenter width divided by the initial tenter width and can be reported a number or number times or numbers as is the case with MD stretching. Greater stretch ratios for TD stretching result in thinner films with greater orientation in the TD. The stretch ratio when stretching the polyethylene films described herein in the transverse direction can be 1× to 12× (or 3× to 7×, or 5× to 9×, or 8× to 12×). One skilled in the art without undo experimentation can determine suitable temperatures and tenter frame operating parameters in a given TDO stage of film production for producing the desired stretch ratios.

A polyethylene composition in accordance with those described herein can be stretched in the transverse and or machine direction over a large range of temperatures. For example, the polyethylene can be stretched in the machine direction over a temperature range of at least 3° C., preferably at least 6° C., preferably at least 7° C., preferably at least 8° C., preferably at least 10° C., preferably at least 12° C., alternately from 3 to 20° C., alternately from to 15° C.

Likewise, a polyethylene composition can be stretched in the transverse direction over a temperature range of at least 3° C., at least 5° C., preferably at least 6° C., preferably at least 7° C., preferably at least 8° C., preferably at least 10° C., preferably at least 12° C., alternately from 3 to 20° C., alternately from 3 to 15° C., alternately from 3 to 10° C., alternately from 3 to 6° C.

Preferably the film can be stretched in the transverse direction without tearing the web and creating gauge inhomogeneities, over a temperature range of at least 3° C., at least 5° C., preferably at least 6° C., preferably at least 7° C., preferably at least 8° C., preferably at least 10° C., preferably at least 12° C., alternately from 3 to 20° C., alternately from 3 to 15° C., alternately from 3 to 10° C., alternately from 3 to 6° C.

Preferably the film can be stretched in the machine direction without web instability and large gauge variations, over an temperature range of at least 3° C., preferably at least 6° C., preferably at least 7° C., preferably at least 8° C., preferably at least 10° C., preferably at least 12° C., alternately from 3 to 20° C., alternately from 5 to 15° C. The broader stretching temperature range in both MD and TD section allows one to have more flexibility in operating the machinery in terms of accessible line speed and stretch ratios.

The oriented (e.g., biaxially-oriented) polyethylene films described herein may be used as monolayer films or as one or more layers of a multilayer film. Examples of other layers include, but are not limited to, unstretched polymer films, MDO polymer films, and other oriented polymer films of polymers like polyethylene, polypropylene, polyethylene terephthalate, polystyrene, polyamide, and the like.

Similarly, a polyethylene composition according to any of various embodiments may be used as part of a different type of monolayer film, or as one or more layers of a multilayer film (e.g., a non-BOPE or even a non-oriented film). Any monolayer film (or any one or more layers of a multilayer film) may be formed from the polyethylene composition or a blend comprising the polyethylene composition, optionally with other formulation components (additives, other polymeric materials, hydrocarbon resins, etc., as known in the art).

Specific end use films include, for example, blown films, cast films, stretch films, stretch/cast films, stretch cling films, stretch hand wrap films, machine stretch wrap, shrink films, shrink wrap films, green house films, laminates, and laminate films. Exemplary films are prepared by any conventional technique known to those skilled in the art, such as for example, techniques utilized to prepare blown, extruded, and/or cast stretch and/or shrink films (including shrink-on-shrink applications).

The oriented polyethylene films described herein (alone or as part of a multilayer film), and/or other films made from polyethylene compositions described herein, are useful end use applications that include, but are not limited to, film-based products, shrink film, cling film, stretch film, sealing films, snack packaging, heavy-duty bags, grocery sacks, baked and frozen food packaging, diaper back-sheets, house wrap, medical packaging (e.g., medical films and intravenous (IV) bags), industrial liners, membranes, and the like.

The films can further be embossed, or produced or processed according to other known film processes. The films can be tailored to specific applications by adjusting the thickness, materials and order of the various layers, as well as the additives in or modifiers applied to each layer.

The films may vary in thickness depending on the intended application; however, films of a thickness from 1 m to 250 m are usually suitable. Films intended for packaging are typically from 10 to 60 microns thick. The thickness of the sealing layer is typically 0.2 m to 50 m. There may be a sealing layer on both the inner and outer surfaces of the film or the sealing layer may be present on only the inner or the outer surface. Films intended for heavier use (such as geomembranes), may be from 25 m to 260 m thick, such as from 25 m to 130 m thick, preferably from 50 m to 110 m thick.

In another embodiment, one more layers may be modified by corona treatment, electron beam irradiation, gamma irradiation, or microwave irradiation.

### Additional Articles

Additional examples of desirable articles of manufacture made from compositions of the present disclosure may include one or more of: sheets, fibers, woven and nonwoven fabrics, automotive components, furniture, sporting equipment, food storage containers, transparent and semi-transparent articles, toys, tubing and pipes, sheets, packaging, bags, sacks, coatings, caps, closures, crates, pallets, cups, non-food containers, pails, insulation, and/or medical devices. Further examples include automotive components, wire and cable jacketing, pipes, agricultural films, geomembranes, toys, sporting equipment, medical devices, casting and blowing of packaging films, extrusion of tubing, pipes and profiles, outdoor furniture (e.g. garden furniture), playground equipment, boat and water craft components, and other such articles. In particular, the compositions are suitable for automotive components such as bumpers, grills, trim parts, dashboards, instrument panels, exterior door and hood components, spoiler, wind screen, hub caps, mirror housing, body panel, protective side molding, and other interior and external components associated with automobiles, trucks, boats, and other vehicles.

Other useful articles and goods may include: crates, containers, packaging, labware, such as roller bottles for culture growth and media bottles, office floor mats, instrumentation sample holders and sample windows; liquid storage containers such as bags, pouches, and bottles for storage and IV infusion of blood or solutions; packaging material including those for medical devices or drugs including unit-dose or other blister or bubble pack as well as for wrapping or containing food preserved by irradiation. Other useful items include medical tubing and valves for any medical device including infusion kits, catheters, and respiratory therapy, as well as packaging materials for medical devices or food which is irradiated including trays, as well as stored liquid, such as water, milk, or juice containers including unit servings and bulk storage containers as well as transfer means such as tubing and pipes.

### Extrusion Coating

A polyethylene composition may be used in extrusion coating processes and applications. Extrusion coating is a plastic fabrication process in which molten polymer is extruded and applied onto a non-plastic support or substrate, such as paper or aluminum in order to obtain a multi-material complex structure. This complex structure typically combines toughness, sealing and resistance properties of the polymer formulation with barrier, stiffness or aesthetics attributes of the non-polymer substrate. In this process, the substrate is typically fed from a roll into a molten polymer as the polymer is extruded from a slot die, which is similar to a cast film process. The resultant structure is cooled, typically with a chill roll or rolls, and would into finished rolls.

Extrusion coating materials are typically used in food and non-food packaging, pharmaceutical packaging, and manufacturing of goods for the construction (insulation elements) and photographic industries (paper).

### EXAMPLES

Three inventive example ethylene-butene copolymers (IE1-3) were made using two slurry loop reactors in series according to the present disclosure, using a Z—N catalyst, so as to obtain the polyethylene compositions IE1, IE2, and IE3, each having 55% LMWF (made in the first series reactor) and 45% HMWF (made in the second series reactor). After the polymerization process, the resulting slurry was separated from the diluent and dried. From there, the polymer was sent to the finishing section. In this latest section, the branching content was tuned by a post-reactor modification of the granules, air was injected into the mixer (ZSK380 Kobe Mixer with a Maag Gear Pump) at flow ratio of air to production rate of 0.21 lbAir/lbPE (+/−50% range variation) and orifice gate temperature of ca. 440±5° F. In addition, antioxidant and neutralizing additives were added to the product as the granules were finished into a final pelletized form.

Table 1 below provides structural properties of IE1, IE2, and IE3, as well as comparative examples CE1, CE2, CE3, CE4, and CE5. Of those, CE1, 4, and 5 are bimodal high density PE compositions, and CE2 and CE3 are unimodal high density PE compositions.

TABLE 1
Example Polyethylene Composition Properties

| | C-1 | C-2 | C-3 | C-4 | C-5 | I-1 | I-2 | I-3 |
|---|---|---|---|---|---|---|---|---|
| MI, g/10 min | 0.4 | 0.77 | 0.76 | 0.48 | 0.49 | 0.62 | 0.66 | 0.83 |
| (2.16 kg, | | | | | | | | |
| 190° C.) | | | | | | | | |
| HLMI, | 36 | 48 | 25 | 30 | 38 | 47 | 50 | 59 |
| g/10 min | | | | | | | | |
| (21.6 kg, | | | | | | | | |
| 190° C.) | | | | | | | | |
| MIR | 90 | 62 | 33 | 63 | 78 | 76 | 76 | 71 |
| Density, g/cm³ | 0.9572 | 0.9609 | 0.9622 | 0.9582 | 0.9572 | 0.9587 | 0.9607 | 0.9608 |
| M_{w} (IR), | 141,646 | 130,879 | 144,799 | 167,416 | 153,610 | 159,614 | 137,045 | 148,533 |
| g/mol | | | | | | | | |
| M_{z} (IR), g/mol | 846,677 | 1,036,222 | 758,676 | 1,071,872 | 961,879 | 1,076,929 | 919,682 | 1,007,417 |
| Mₙ (IR), g/mol | 11,662 | 12,475 | 19,403 | 14,164 | 11,513 | 10,797 | 10,793 | 10,607 |
| Comonomer | 0.82 | 0.01 | 0.40 | 0.32 | 0.69 | 0.99 | 0.56 | 0.79 |
| Content (wt | | | | | | | | |
| %) | | | | | | | | |
| Mw/Mn | 12.15 | 10.49 | 7.46 | 11.82 | 13.34 | 14.78 | 12.70 | 14.00 |
| Mz/Mw | 5.98 | 7.92 | 5.24 | 6.40 | 6.26 | 6.75 | 6.71 | 6.78 |
| Mz/Mn | 72.60 | 83.06 | 39.10 | 75.68 | 83.55 | 99.74 | 85.21 | 94.98 |
| g′_{LCB} | 0.752 | 0.939 | 0.814 | 0.722 | 0.765 | 0.663 | 0.678 | 0.666 |
| η_{0.01}, Pa*s | 69,767 | 31,259 | 20,532 | 31,279 | 34,897 | 29,715 | 29,378 | 23,025 |
| η₁₀₀, Pa*s | 1,389 | 1,159 | 1,896 | 1,570 | 1,406 | 1,253 | 1,230 | 1,126 |
| η₆₂₈, Pa*s | 401 | 388 | 632 | 479 | 417 | 382 | 379 | 357 |
| DST | 0.980 | 0.963 | 0.908 | 0.950 | 0.960 | 0.958 | 0.958 | 0.951 |
| LOW Ratio | 0.018 | 0.026 | 0.03 | 0.022 | 0.023 | 0.033 | 0.034 | 0.042 |
| Broad-High | 0.050 | 0.136 | 0.059 | 0.100 | 0.118 | 0.238 | 0.214 | 0.365 |
| Ratio | | | | | | | | |

As can be seen from the g′_{LCB} values in Table 1, IE1-3 all have substantially greater degree of long chain branched architecture as compared to the comparative resins, while also exhibiting generally lower viscosities at higher shear rates, showing a significant advantage in processing. Note that, although DST of the IE1-3 is lower than some comparative examples, this is generally due to having lower viscosity at low shear rates to start with. And at any rate, the advantageously low viscosities for IE1-3 at high shear rates (e.g., 628 rad/s) comport more closely with viscosity likely to be encountered during extrusion and other processing. The advantageously lower viscosities are illustrated also in FIGS. 1a and 1b. Each of those figures shows complex viscosity vs. frequency of IE1-3, with FIG. 1a also showing comparative examples CE1 and CE2; and FIG. 1b also showing comparative examples CE3, CE4, and CE5.

The unique combination of properties lending to the excellent processing of the present IE1-3 is further highlighted in the LOW Ratio and Broad-High Ratios reported in Table 1, wherein IE1-3 have substantially higher values of each ratio as compared to all other comparative examples. The import of each ratio is set forth above in the detailed description.

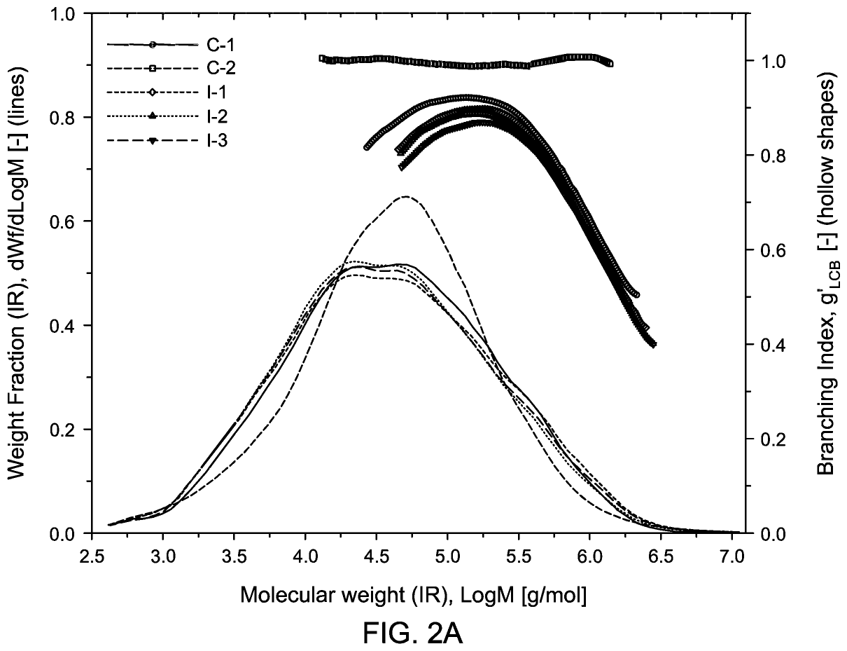

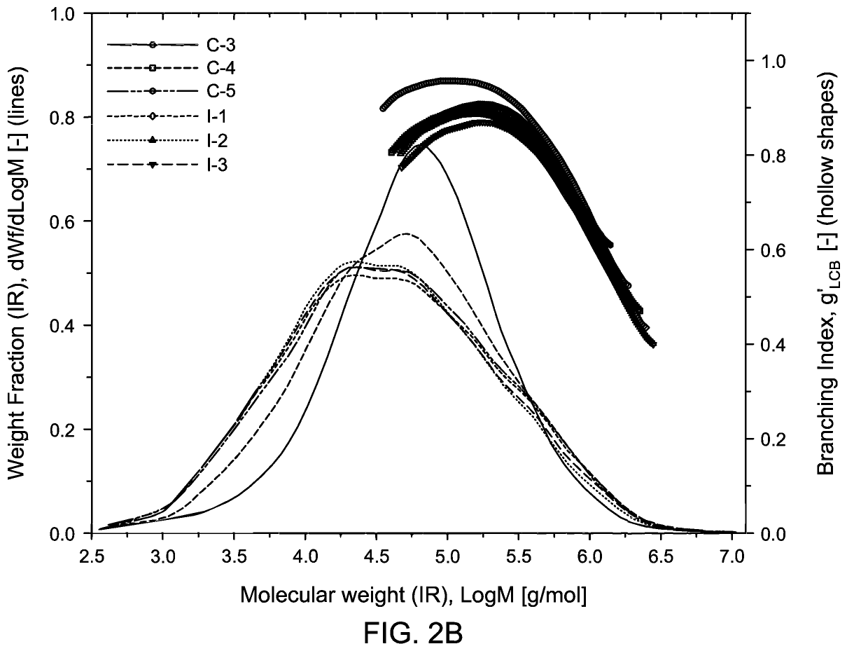

Finally, in FIGS. 2a and 2b, we also report the molecular weight distributions of all samples, as determined by GPC in accordance with the detailed description above. FIG. 2a shows the inventive examples as compared to CE1 and CE2; FIG. 2b shows the inventive examples as compared to CE3, CE4, and CE5. IE1-IE3 exhibit quite broad distribution with two discernable peaks illustrating the multi-modal nature of these polyethylene compositions. The substantially broader nature as compared to CE1-CE5 also illustrates the superior processability one can expect from the present polyethylene compositions.

The inventive examples exhibit an excellent combination of properties, particularly in their combination of Mz, g′_{LCB}, Mz/Mn, Mw/Mn, and viscosity at 628 rad/s, demonstrating good properties in terms of stiffness, heat resistance, and the like, while offering a high degree of orientability (MD/TD stretch ratio) with a homogeneous gauge and a good degree of extrudability in terms of low head pressure with competitive line output. In short, they successfully balance desired end film properties with excellent processability, and would therefore be expected to be superior candidates particularly for applications like BOPE films; furthermore, given their high density nature and unique molecular design, they will provide substantially superior mechanical strength properties as compared to their counterparts. It is surprising and highly advantageous to achieve such good processability in such high-density, high-strength polyethylene compositions. BOPE films made from such polyethylene compositions open up several advantageous possibilities in the film-making space, with a particular example being all-PE films that can replace incumbent solutions using PP or PET and other materials, while maintaining the strength and barrier properties that these films need for end uses such as food and other packaging applications.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

We claim:

1. A polyethylene composition comprising:
80 wt % to 99.9 wt % ethylene content, based on ethylene content plus comonomer content;
20 wt % to 0.1 wt % a C₃ to C₄₀ α-olefin comonomer content, based on ethylene content plus comonomer content; and wherein the polyethylene composition has the following properties:
a density within the range from 0.930 g/cm³ to 0.975 g/cm³;
Mw/Mn of 10 or more;
Mz of 800,000 g/mol or more;
Mz/Mn of 70 or more; and
g′LCB of 0.75 or less.

2. The polyethylene composition of claim 1, wherein:
density is within the range from 0.935 to 0.970 g/cm³;
Mw/Mn is 12 or more;
Mz of 900,000 g/mol or more;
Mz/Mn is 85 or more; and
g′LCB is 0.70 or less.

3. The polyethylene composition of claim 1, wherein the C₃ to C₄₀ α-olefin comonomer is selected from 1-butene, 1-hexene, 1-octene, and combinations thereof.

4. The polyethylene composition of claim 1, further having the following properties:
Mw within the range from 120,000 to 180,000 g/mol; and
Mn within the range from 8,000 to 15,000 g/mol.

5. The polyethylene composition of claim 1, further having the following properties:
MI (2.16 kg, 190° C.) within the range from 0.5 to 1.0 g/10 min;
HLMI (21.6 kg, 190° C.) within the range from 30 to 70 g/10 min;
MIR (HLMI/MI) within the range from 30 to 140.

6. The polyethylene composition of claim 1, further having the following properties:
degree of shear thinning (DST) within the range from 0.930 to 0.970;
complex viscosity at 628 rad/s within the range from 300 to 400 Pa*s; and
complex viscosity at 0.01 rad/s within the range from 20,000 to 35,000 Pa*s.

7. The polyethylene composition of claim 1, further having LOW Ratio of greater than 0.03, where the LOW Ratio is defined as:
$$\frac{MI {η}_{628}}{{M}_{n} {g}_{LCB}^{′}}$$
where MI is melt index (g/10 min at 2.16 kg, 190° C.); I₆₂₈ is the complex viscosity at 628 rad/s (in Pa*s); Mn is number-average molecular weight (g/mol); and g′_{LCB} is the long-chain branching index.

8. The polyethylene composition of claim 7, having LOW Ratio within the range from 0.031 to 0.6.

9. The polyethylene of claim 1, further having Broad-High Ratio of greater than or equal to 0.2, where the Broad-High Ratio is defined as:
$$\frac{Mz * HLMI}{Mn * {g}_{LCB}^{′} * {η}_{0.01}}$$
where Mz and Mn are z- and n- average molecular weights, respectively (g/mol); HLMI is high load melt index (g/10 min at 21.6 kg, 190° C.); η_{0.01} is the complex viscosity at 0.01 rad/s (in Pa*s); and g′LCB is the long-chain branching index.

10. The polyethylene composition of claim 9, having Broad-High Ratio within the range from 0.20 to 6.0.

11. The polyethylene composition of claim 1, wherein the polyethylene composition comprises from 50.1 to 59 wt % of a low molecular weight fraction (LMWF) and from 41 to 49.9 wt % of a high molecular weight fraction (HMWF), wherein the LMWF has higher density than the HMWF.

12. The polyethylene composition of claim 1, wherein the polyethylene composition exhibits a bimodal molecular weight distribution as determined by GPC.

13. A polyethylene composition having density within the range from 0.930 g/cm³ to 0.975 g/cm³ and comprising 98 to 99.9 wt % units derived from ethylene and the balance derived from a comonomer selected from 1-butene, 1-hexene, and 1-octene, said wt % s based on ethylene content plus comonomer content;
further wherein the polyethylene composition has one or both of the following:
(a) LOW Ratio of greater than 0.03, where the LOW Ratio is defined as:
$$\frac{MI {η}_{628}}{{M}_{n} {g}_{LCB}^{′}}$$
where MI is melt index (g/10 min at 2.16 kg, 190° C.); I₆₂₈ is the complex viscosity at 628 rad/s (in Pa*s); Mn is number-average molecular weight (g/mol); and g′LCB is the long-chain branching index; and
(b) Broad-High Ratio of greater than or equal to 0.2, where the Broad-High Ratio is defined as:
$$\frac{Mz * HLMI}{Mn * {g}_{LCB}^{′} * {η}_{0.01}}$$
where Mz and Mn are z- and n- average molecular weights, respectively (g/mol); HLMI is high load melt index (g/10 min at 21.6 kg, 190° C.); η_{0.01} is the complex viscosity at 0.01 rad/s (in Pa*s); and g′_{LCB} is the long-chain branching index.

14. The polyethylene composition of claim 13, having both LOW Ratio within the range from 0.031 to 0.05 and Broad-High Ratio within the range from 0.20 to 6.0.

15. The polyethylene composition of claim 13, further having one or more of the following properties:
(a) Mw within the range from 120,000 to 180,000 g/mol;
(b) Mn within the range from 8,000 to 15,000 g/mol;
(c) MI (2.16 kg, 190° C.) within the range from 0.5 to 1.0 g/10 min;
(d) HLMI (21.6 kg, 190° C.) within the range from 30 to 70 g/10 min;
(e) MIR (HLMI/MI) within the range from 30 to 140 and
(f) degree of shear thinning (DST) within the range from 0.930 to 0.970.

16. The polyethylene composition of claim 15, having all of the properties (a)-(f).

17. A film comprising the polyethylene composition of claim 1.

18. The film of claim 17, wherein the film is uniaxially or biaxially oriented polyethylene film.

19. The film of claim 18, wherein the film is a multilayer film.

20. The film of claim 17, wherein the film is a multilayer film, and at least one layer comprises a biaxially oriented polyethylene film layer comprising the polyethylene composition.
